(19) United States
(12) Patent Application Publication
(10) Pub. No.: US 2004/0116648 A1
(43) Pub. Date: Jun. 17, 2004

(54) Process for the separation of residual monomers and oligomers from polycarbonate

(76) Inventors: Stefan Westernacher, Kempen (DE); Hermann Kauth, Krefeld (DE); Klaus Fassbender, Rheinberg (DE); Bernd Willenberg, Bergisch Gladbach (DE); Andreas Frankenau, Kempen (DE); Rainer Mellis, Duisburg (DE); Gary Conklin, Krefeld (DE); Christoph Biedron, Moers (DE)

Correspondence Address: BAYER POLYMERS LLC, 100 BAYER ROAD, PITTSBURGH, PA, 15205, US

(21) Appl. No.: 10/686,076

(22) Filed: Oct. 15, 2003

(30) Foreign Application Priority Data
Oct. 16, 2002 (DE) 10248165.2

(51) Int. Cl. C08G 64/00

(52) U.S. Cl. 528/198; 528/371

(57) ABSTRACT

An improvement to the process of producing polycarbonate resin by the phase interface method is disclosed. The improvement comprising adding at least one chlorinated aromatic hydrocarbon to the organic phase.

### FIELD OF THE INVENTION

The present invention relates to polycarbonates and more particularly to the phase interface process for their preparation.

### SUMMARY OF THE INVENTION

An improvement to the process of producing polycarbonate resin by the phase interface method is disclosed. The improvement comprising adding at least one chlorinated aromatic hydrocarbon to the organic phase.

### BACKGROUND OF THE INVENTION

It has been described in the literature that the oligomer and residual monomer content in polycarbonate can be reduced by addition of a solvent as entrainment agent before or during the extrusion. The use of ethylene glycol, glycerol or chlorobenzene and other entrainment agents is described in DE-A 29 17 396 and U.S. Pat. No. 4,306,057. The results achievable by these known methods are however not satisfactory.

It is also known that chlorinated hydrocarbons can be successfully used as solvents in the phase interface synthesis of polycarbonate, see for example Schnell “Chemistry and Physics of Polycarbonates”, Polymer Reviews, Volume 9, Interscience Publishers, New York, London, Sydney 1964, pp. 33-70 as well as the other literature sources regarding the phase interphase process cited there (see below). Here too however only unsatisfactory results are obtained as regards the oligomer and residual monomer content in the polycarbonate. On the basis of the prior art the objective therefore existed of providing a process for making polycarbonate having reduced, oligomer and residual monomer content.

### DETAILED DESCRIPTION OF THE INVENTION

It has surprisingly now been found that the addition of chlorinated aromatic hydrocarbons to a solvent system is suitable for achieving the aforementioned objective.

The present invention accordingly provides a process for the production of polycarbonates by the phase interface process, characterised in that chlorinated aromatic hydrocarbons are added to the organic phase used in the phase interface process, preferably in an amount of 0.001 to 90 wt. %, particularly preferably 30 to 50 wt. %, referred to the organic phase.

Surprisingly the residual monomer content and the oligomer content in the polycarbonate after isolation of the polycarbonate at a purity of the isolated polycarbonate of 99.95 to 99.9999% is thereby reduced by 5% to 50% compared to the residual monomer content and the oligomer content in the polycarbonate solution.

Surprisingly the reduction of the residual monomer content and oligomer content may be achieved directly during the process of the production of the polycarbonate, and not only in a downstream-connected extrusion step as described in the literature (DE-A 29 17 396, U.S. Pat. No. 4,306,057).

Suitable solvents according to the invention are chlorinated aromatic hydrocarbons, preferably monochlorobenzene or dichlorobenzene, also chlorinated toluenes and mixtures of these compounds, monochlorobenzene being particularly preferred.

The polycarbonate is produced by the so-called phase interface process. This process for polycarbonate synthesis has been described many times in the literature, including for example in

Schnell, “Chemistry and Physics of Polycarbonates”, Polymer Reviews, Volume 9, Interscience Publishers, New York, London, Sydney 1964, p. 3370;

D. C. Prevorsek, B. T. Debona and Y. Kesten, Corporate Research Center, Allied Chemical Corporation, Morristown, N. J. 07960: “Synthesis of Poly(ester Carbonate) Copolymers” in Journal of Polymer Science, Polymer Chemistry Edition, Vol. 18, (1980), pp. 75-90;

D. Freitag, U. Grigo, P. R. Müller, N. Nouvertne', BAYER AG, “Polycarbonates” in Encyclopedia of Polymer Science and Engineering, Volume 11, 2^{nd} Edition, 1988, pp. 651-692, and finally

Dres. U. Grigo, K. Kircher and P. R. Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, pp. 118-145, all incorporated herein by reference

as well as for example in EP-A 0 517 044 and many other patent applications.

According to this process the phosgenation of a disodium salt of a bisphenol (or a mixture of different bisphenols) in aqueous-alkaline solution (or suspension) is carried out in the presence of an inert organic solvent or solvent mixture, which forms a second phase. The oligocarbonates that are formed and that are mainly present in the organic phase are condensed with the aid of suitable catalysts to form high molecular weight polycarbonates that are dissolved in the organic phase. The organic phase is finally separated and the polycarbonate is isolated by various working-up steps.

In this process an aqueous phase containing NaOH, one or more bisphenols and water may be used, wherein the concentration of this aqueous solution with respect to the sum total of bisphenols, calculated not as sodium salt but as free bisphenol, may vary between 1 and 30 wt. %, preferably between 3 and 25 wt. %, particularly preferably between 3 and 8 wt. % for polycarbonates with an Mw>45,000, and 12 to 22 wt. % for polycarbonates with an M_{w}<45,000. In this connection it may be necessary in the case of higher concentrations to control the temperature of the solutions. The sodium hydroxide used to dissolve the bisphenols may be employed in solid form or as aqueous sodium hydroxide solution. The concentration of the sodium hydroxide solution is governed by the target concentration of the desired bisphenolate solution, but as a rule is between 5 and 25 wt. %, preferably between 5 and 10 wt. %, or may be chosen to be more concentrated, in which case it is then diluted with water. In the process involving subsequent dilution sodium hydroxide solutions with concentrations between 15 and 75 wt. %, preferably between 25 and 55 wt. %, optionally thermostatically controlled, are used. The alkali content per mole of bisphenol depends very largely on the structure of the bisphenol but varies as a rule between 0.25 mole of alkali per mole of bisphenol and 5.00 mole of alkali per mole of bisphenol, preferably 1.5-2.5 mole of alkali per mole of bisphenol, and in the case where bisphenol A is used as sole bisphenol, is 1.85-2.15 mole of alkali. If more than one bisphenol is used, then these may be dissolved together. It may however also be advantageous to dissolve the bisphenols separately in an optimal alkaline phase and to meter in the solutions separately or alternatively to add them combined to the reaction. In addition it may be advantageous to dissolve the bisphenol or bisphenols not in sodium hydroxide solution but in dilute bisphenolate solution to which additional alkali has been added. The dissolution processes may start from solid bisphenol, generally in flakes or prill form, or also from molten bisphenol. The sodium hydroxide or sodium hydroxide solution that is used may be produced by the amalgam process or the so-called membrane process. Both processes have been in use for a long time and are known to the person skilled in the art. Sodium hydroxide produced by the membrane process is preferably employed.

The thus prepared aqueous phase is phosgenated together with an organic phase consisting of solvents for polycarbonate that are inert to the reactants and that form a second phase.

The optionally employed metering of bisphenol after or during the addition of the phosgene may be continued as long as phosgene or its immediate secondary products, namely chlorinated carbonic acid esters, are present in the reaction solution.

The synthesis of polycarbonates from bisphenols and phosgenes in an alkaline medium is an exothermic reaction and is carried out in a temperature range from

−5° C. to 100° C., preferably 15° C. to 80° C., most particularly preferably 25° C. to 65° C., wherein the reaction possibly has to be carried out under excess pressure depending on the solvent or solvent mixture.

Suitable diphenols for the production of the polycarbonates to be used according to the invention include for example hydroquinone, resorcinol, dihydroxydi-phenyl, bis-(hydroxyphenyl)alkanes, bis-(hydroxyphenyl)cycloalkanes, bis-(hydroxyphenyl)sulfides, bis-(hydroxyphenyl)ethers, bis-(hydroxyphenyl)ketones, bis-(hydroxyphenyl)sulfones, bis-(hydroxyphenyl)sulfoxides, (α,α′-bis-(hydroxyphenyl)diisopropylbenzenes, as well as their alkylated, nuclear-alkylated and nuclear-halogenated compounds.

Preferred diphenols are 4,4′-dihydroxydiphenyl, 2,2-bis-(4-hydroxyphenyl)-1-phenylpropane, 1,1-bis-(4-hydroxyphenyl)phenylethane, 2,2-bis-(4-hydroxy-phenyl)-propane, 2,4-bis-(4-hydroxyphenyl)-2-methylbutane, 1,1-bis-(4-hydroxyphenyl)-m/p-diisopropylbenzene, 2,2-bis-(3-methyl-4-hydroxy-phenyl)propane, bis-(3,5-dimethyl-4-hydroxyphenyl)methane, 2,2-bis-(3,5-dimethyl-4-hydroxyphenyl)propane, bis-(3,5-dimethyl-4-hydroxyphenyl)sulfone, 2,4-bis-(3,5-dimethyl-4-hydroxyphenyl)-2-methylbutane, 1,1-bis-(3,5-dimethyl-4-hydroxyphenyl)-m/p-diisopropylbenzene and 1,1-bis-(4-hydroxyphenyl)-3,3,5-trimethylcyclohexane.

Particularly preferred diphenols are 4,4′-dihydroxydiphenyl, 1,1-bis-(4-hydroxyphenyl)- phenylethane, 2,2-bis-(4-hydroxyphenyl)propane, 2,2-bis-(3,5-dimethyl-4-hydroxy- phenyl)propane, 1,1-bis-(4-hydroxyphenyl)cyclohexane and 1,1-bis-(4-hydroxy-phenyl)-3,3,5-trimethylcyclohexane.

These and further suitable diphenols are described for example in U.S. Pat. Nos. 2,999,835, 3,148,172, 2,991,273, 3,271,367, 4,982,014 and 2,999,846, in German laid-open specifications 1 570 703, 2 063 050, 2 036 052, 2 211 956 and 3 832 396, in French patent specification 1 561 518, in the monograph by H. Schnell “Chemistry and Physics of Polycarbonates”, Interscience Publishers, New York 1964, pp. 28 ff.; pp. 102 ff., and in D. G. Legrand, J. T. Bendler, “Handbook of Polycarbonate Science and Technology”, Marcel Dekker, New York 2000, pp. 72 ff.

In the case of homopolycarbonates only one diphenol is used, while in the case of copolycarbonates several diphenols are used, in which connection the bisphenols that are used as well as all other chemicals and auxiliary agents added to the synthesis may obviously be contaminated with impurities originating from their actual synthesis, handling and storage, although it is desirable to use raw materials that are as clean as possible.

The organic phase may contain one solvent or mixture of several solvents. Suitable solvents include aromatic hydrocarbons such as benzene, toluene, m/p/o-xylene or aromatic ethers such as anisole, alone or as a mixture. Also suitable are chlorinated aliphatic hydrocarbons, preferably dichloromethane, trichloroethylene, 1,1,1-trichloroethane and 1, 1,2-trichloroethane or their mixtures. Another embodiment of the synthesis uses solvents that do not dissolve but only swell polycarbonate. Accordingly non-solvents for polycarbonate may also be used in combination with solvents for polycarbonate. In this case solvents such as tetrahydrofuran, 1,3-/1,4-dioxane or 1,3-dioxolane that are also soluble in the aqueous phase may then be used as solvents if the solvent partner forms the second organic phase. According to the invention 0.001 to 90 wt. % of chlorinated solvents, particularly preferably 30 to 50 wt. %, from the group comprising chlorinated aromatic hydrocarbons, preferably monochlorobenzene or dichlorobenzene and chlorinated toluenes and mixtures of these compounds, particularly preferably monochlorobenzene, are added to this solvent system/solvent mixture. The addition of the chlorinated aromatic hydrocarbon is not restricted to the reaction, but may also take place at any other time during the production process of the polycarbonate solution, including during the isolation steps.

The two phases forming the reaction mixture are mixed in order to accelerate the reaction. This is effected by supplying energy via shear forces, i.e. pumps or stirrers or by static mixers, or by generating turbulent flow by means of nozzles and/or diaphragms. Combinations of these measures may also be employed. The combination of measures as well as single measures may also be repeated. Anchor, propeller, MIG stirrers, etc., such as are described for example in Ullmann “Encyclopedia of Industrial Chemistry”, 5 h Edition, Vol. B2, pp. 251 ff. are preferably used as stirrers. Centrifugal pumps, often also multi-stage pumps are employed as pumps, 2- to 9-stage pumps being preferred. Perforated diaphragms or alternatively tapering tubular pieces or also Venturi or Lefos nozzles are used as nozzles and/or diaphragms.

The phosgene may be added in gaseous or liquid form or dissolved in solvents. The phosgene excess that is employed, referred to the sum total of the bisphenols used, is between 3 and 100 mole %, preferably between 5 and 50 mole %. In this connection the pH value of the aqueous phase during and after addition of phosgene is maintained in the alkaline range, preferably between 8.5 and 12, by single or repeated additional metering in of sodium hydroxide solution or appropriate additional metering in of bisphenolate solution, whereas after the addition of catalyst the pH should be between 10 and 14. The temperature during the phosgenation is 25° to 85° C., preferably 35° to 65° C.; the phosgenation may also be carried out under excess pressure depending on the solvent that is used.

The phosgene may be metered directly into the aforedescribed mixture of the organic and aqueous phase or be partially metered, before the mixing of the phases, into one of the two phases, which is then mixed with the corresponding other phase. In addition the phosgene may be metered wholly or partially into a partial stream of the synthesis mixture from both phases which is taken from the main stream, this partial stream preferably being recycled to the main stream before the catalyst addition. In another embodiment the aforedescribed aqueous phase is mixed with the phosgene-containing organic phase and is then added after a residence time of 1 second to 5 minutes, preferably 3 seconds to 2 minutes, to the recycled partial stream mentioned above, or alternatively the two phases, namely the aforedescribed aqueous phase together with the phosgene-containing organic phase, are mixed directly in the recycled partial stream mentioned above. In all these embodiments the aforedescribed pH ranges should be observed and if necessary maintained by single or repeated additional metering in of sodium hydroxide solution or appropriate additional metering in of bisphenolate solution. Also, the temperature range must be maintained, if necessary by cooling or dilution.

The polycarbonate synthesis may be effected continuously or discontinuously. The reaction may accordingly take place in stirred vessels, tubular reactors, pump reactors or stirred vessel cascades or combinations thereof, in which connection it should be ensured by employing the already mentioned mixing devices that, as far as possible, the aqueous and organic phases demix only when the synthesis mixture has fully reacted, i.e. no longer contains saponifiable chlorine from phosgene or chlorinated carbonic acid esters.

The monofunctional chain terminators required to regulate the molecular weight, such as phenol or alkylphenols, in particular phenol, p-tert.-butylphenol, isooctylphenol, cumylphenol, their chlorinated carbonic acid esters or acid chlorides of monocarboxylic acids or mixtures of these chain terminators, are added either together with the bisphenolate or bisphenolates to the reaction, or alternatively are added at any appropriate time during the synthesis as long as phosgene or chlorinated carbonic acid terminal groups are still present in the reaction mixture, or in the case where acid chlorides and chlorinated carbonic acid esters are used as chain terminators, as long as sufficient phenolic terminal groups of the polymer that is being formed are available. Preferably the chain terminator or terminators are however added after the phosgenation at a site or at a time when phosgene is no longer present but the catalyst has not yet been added, or are added before the catalyst, together with the catalyst, or parallel thereto.

In the same way branching agents or branching agent mixtures that are possibly used are added to the synthesis, normally however before the chain terminators. Trisphenols, quaternary phenols or acid chlorides of tricarboxylic acids or tetracarboxylic acids are normally used, as well as mixtures of the polyphenols or acid chlorides.

Some of the compounds containing three or more phenolic hydroxyl groups that may be used include for example:

phloroglucinol,

4,6-dimethyl-2,4,6-tri-(4-hydroxyphenyl)heptene-2,

4,6-dimethyl-2,4,6-tri-(4-hydroxyphenyl)heptane,

1,3,5-tri-(4-hydroxyphenyl)benzene,

1,1,1-tri-(4-hydroxyphenyl)ethane,

tri-(4-hydroxyphenyl)phenylmethane,

2,2-bis-[4,4-bis-(4-hydroxyphenyl)cyclohexyl]propane,

2,4-bis-(4-hydroxyphenylisopropyl)phenol,

tetra-(4-hydroxyphenyl)methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole,

Preferred branching agents are 3,3-bis-(3-methyl-4-hydroxyphenyl)-2-oxo-2,3-dihydroindole and 1,1,1-tri-(4-hydroxyphenyl)ethane.

The catalysts used in the phase interface synthesis include tertiary amines, in particular triethylamine, tributylamine, trioctylamine, N-ethylpiperidine,

N-methylpiperidine, N-i/n-propylpiperidine; quaternary ammonium salts such as tetrabutylammonium/tributylbenzylammonium/tetraethylammonium hydroxide/chloride/bromide/hydrogen sulfate/tetrafluoroborate, as well as the phosphonium compounds corresponding to the ammonium compounds. In this context ammonium and phosphonium compounds are also jointly referred to as onium compounds. These compounds are described as typical phase interface catalysts in the literature, are commercially available, and are known to the person skilled in the art. The catalysts may be added individually, as a mixture, or also together and in succession to the synthesis. They are optionally also added before the phosgenation, though addition after the introduction of the phosgene is preferred irrespective of whether one onium compound or mixtures of onium compounds are used as catalysts, in which case an addition before the metering of the phosgene is preferred. The metering in of the catalyst or catalysts may take place in bulk, in an inert solvent, preferably that used for the polycarbonate synthesis, or also as an aqueous solution, and in the case of tertiary amines as their ammonium salts with acids, preferably mineral acids, in particular hydrochloric acid. When using several catalysts or when metering in partial amounts of the total quantity of catalyst different metering procedures may of course also be used at different sites or at different times. The total amount of the catalysts that are used is between 0.001 to 10 mole % referred to moles of bisphenols employed, and is preferably 0.01 to 8 mole %, particularly preferably 0.05 to 5 mole %.

After addition of the phosgene it may be advantageous to mix the organic phase and the aqueous phase, before possibly branching agent (where this is not metered in jointly with the bisphenolate), chain terminator and catalyst are added. Such a post-reaction time may be advantageous after each addition. These subsequent stirring times, insofar as they are employed, are between 10 seconds and 60 minutes, preferably between 30 seconds and 40 minutes and particularly preferably between 1 minute and 15 minutes.

After completion of the reaction the at least two-phase reaction mixture that contains at most only traces (<2 ppm) of chlorinated carbonic acid esters, is allowed to settle for the phase separation. The aqueous alkaline phase is if necessary recycled in whole or in part to the polycarbonate synthesis as aqueous phase, or is added to the waste water treatment stage, where solvent and catalyst fractions are separated and recycled. In another variant of the working-up process, after separating the organic impurities, in particular solvents and polymer residues, and if necessary after adjusting a specific pH value, for example by addition of sodium hydroxide solution, the salt is separated, which may be fed for example to a chlorine-alkali electrolysis plant, while the aqueous phase is optionally recycled to the synthesis.

The organic phase containing the polymer now only has to be purified to remove all contaminants of an alkaline, ionic or catalytic nature.

The organic phase also contains after one or more settling stages, portions of the aqueous alkaline phase in the form of fine droplets as well as the catalyst. The catalyst as a rule is a tertiary amine. The settling stages may be assisted by passage through settling tanks, stirred vessels, coalescers or centrifuges or combinations of these measures. In connection with these stages water may be added at each or some of the separating steps and mixing may be active or passive.

After this coarse separation of the alkaline aqueous phase the organic phase is washed once or several times with dilute acids, i.e. mineral, carboxylic, hydrocarboxylic and/or sulfonic acids. Aqueous mineral acids are preferred, in particular hydrochloric acid, phosphorous acid and phosphoric acid, or mixtures of these acids. The concentration of these acids should be in the range from 0.001 to 50 wt. %, preferably 0.01 to 5 wt. %.

In addition the organic phase is repeatedly washed with deionized or distilled water. The separation of the organic phase, optionally dispersed with portions of the aqueous phase, is carried out after the individual wash stages by means of settling tanks, stirred vessels, coalescers or centrifuges or combination of these measures, in which connection the wash water may be added between the wash stages, if necessary using active or passive mixing equipment.

Acids, preferably dissolved in the solvent used for the polymer solution, may be added between these wash stages or also after the wash process. Gaseous hydrogen chloride and phosphoric acid or phosphorous acid are preferred in this connection, and may optionally also be employed as mixtures.

The purified polymer solution thereby obtained should after the last separation process contain not more than 5 wt. %, preferably less than 1 wt. %, and most particularly preferably less than 0.5 wt. % of water.

The polymer may be isolated from the solution by evaporating the solvent by means of heat, vacuum or a heated entrainment gas.

If the concentration of the polymer solution and possibly also the isolation of the polymer takes place by distilling off the solvent, if necessary by superheating and release of pressure, this is referred to as a “flash” process; see also “Thermische Trennverfahren”, VCH Verlagsanstalt 1988, p. 114; if alternatively a heated carrier gas is sprayed together with the solution to be evaporated, then this is referred to as a “spray evaporation/spray drying”, described for example in Vauck, “Grundoperationen chemischer Verfahrenstechnik”, Deutscher Verlag für Grundstoffindustrie 2000, 11′ Edition, p. 690. All these processes are described in the patent literature and in relevant textbooks and are known to the person skilled in the art.

When removing the solvent by heat (distillation) or the technically more effective flash process, highly concentrated polymer melts are obtained. In the known flash process polymer solutions are repeatedly heated under slight excess pressure to temperatures above the boiling point under normal pressure, and these solutions, superheated with respect to normal pressure, are then flashed in a vessel at a lower pressure, for example normal atmospheric pressure. It may in this connection be advantageous not to allow the change in concentration to become too large in one step, or in other words the rise of temperature during the superheating to become too large in one step, but instead to select a two-step to four-step process.

The residues of the solvent may be removed from the highly concentrated polymer melts that are thereby obtained either directly from the melt using evaporation extruders (BE-A 866 991, EP-A 0 411 510, U.S. Pat. No. 4,980,105, DE-A 33 32 065), thin-layer evaporators (EP-A 0 267 025), falling-film evaporators, strand evaporators or by friction compaction (EP-A 0 460 450), optionally also under the addition of an entrainment agent such as nitrogen or carbon dioxide or by employing a vacuum (EP-A 0 039 96, EP-A 0 256 003, U.S. Pat. No. 4,423,207) or alternatively by subsequent crystallisation (DE-A 34 29 960) and heating of the solvent residues in the solid phase (U.S. Pat. No. 3,986,269, DE-A 20 53 876).

Granules may be obtained by direct spinning of the melt and subsequent granulation, or by using discharge extruders, from which the granules are spun in air or under a liquid, generally water. Additives may also be added to the melt before the spinning, either directly or via a side extruder. If extruders are used, then additives may be added to the melt upstream of this extruder, optionally with the use of static mixers or through side extruders in the extruder.

The present invention also provides the polycarbonates that are obtained by the process according to the invention and also provides for their use for the production of extrudates and molded parts, in particular for use in transparent applications, most particularly in the area of optical applications such as for example sheets, ribbed sheets, glazing, light-diffusing discs, lamp coverings or optical data storage media such as audio CDs, CDR(W)s, DVDs, DVD-R(W)s, MiniDiscs in their various read-only or write once, possibly also completely rewriteable forms.

The extrudates and molded parts made from the polymers according to the invention are also covered by the present invention.

Further applications include for example the following, without however restricting the subject matter of the present invention:

1. Safety panels, which as is known are necessary in many areas of buildings, vehicles and aircraft, as well as helmet shields.

2. Films.

3. Blow-molded articles (see also U.S. Pat. No. 2,964,794), for example 1-gallon to 5-gallon water tanks.

4. Light-permeable panels such as solid panels or in particular hollow panels, for example for covering buildings such as railway stations, greenhouses and lighting installations.

5. Optical data storage media such as audio CDs, CD-R(W)s, DCDs, DVD-R(W)s, and MiniDiscs.

6. Traffic light housings or traffic signs.

7. Foamed articles, optionally printable surface.

8. Threads and wires (see also DE-A 11 37 167).

9. Light technology applications, possibly using glass fibers for applications in the light transmission sector.

10. Translucent modifications containing barium sulfate and/or titanium dioxide and/or zirconium oxide or organic polymeric acrylate rubbers (EP-A 0 634 445, EP-A 0 269 324) for the production of light-permeable and light-scattering molded parts.

11. Precision injection-molded parts such as mountings, e.g. lens mountings; in this connection possibly polycarbonates with glass fibers and optionally an additional content of 1 to 10 wt. % of molybdenum disulfide (referred to the total molding composition) are used.

12. Optical instrument parts, in particular lenses for camcorders and cameras (DE-A 27 01 173).

13. Light transmission carriers, in particular fibre optic cables (EP-AL 0 089 801) and illumination strips.

14. Electrically insulating materials for electrical conductors and for plug housings and sockets as well as capacitors.

15. Mobile telephone housings.

16. Network interface devices.

17. Carrier materials for organic photoconductors.

18. Lamps/lights, automobile headlamps, light-diffusing panels or internal lenses.

19. Medical applications such as oxygenators and dialysis machines.

20. Foodstuffs applications such as bottles, crockery and chocolate molds.

21. Applications in the automobile sector, such as glazing, or in the form of blends with ABS, as bumpers.

22. Sports articles such as slalom poles and ski boot fastenings.

23. Household articles such as kitchen sink units, washbasins and letterbox housings.

24. Housings such as electrical distribution cabinets.

25. Housings for electrical appliances such as toothbrushes, hairdryers, coffee-machines and machine tools such as drills, milling machines, planes and saws.

26. Washing machine portholes.

27. Protective goggles, sunglasses, optical correction glasses and their lenses.

28. Lamp coverings.

29. Packaging foils.

30. Chip containers, chip carriers and boxes for Si wafers.

31. Miscellaneous applications such as stable doors or animal cages.

The following examples are intended to illustrate the present invention without however restricting the scope of the latter.

### EXAMPLES

Polycarbonate is dissolved in the following mixture at 35° C. and 1 bar pressure: 16% PC, 39.5% monochlorobenzene (MCB), 44.5% methylene chloride (MeCl₂). A two-stage evaporation is carried out, following which a solution of 70% PC, 25% MCB and 5% MeCl₂ is obtained at 2.5 bar excess pressure and 188° C. A further concentration of the polycarbonate is carried out in a tubular evaporator (30 mbar vacuum, 300° C.) and in a strand evaporator (1 mbar vacuum, 300° C.). The analysis values of the individual process steps are shown below. The separated oligomers and residual monomers are removed at regular intervals from the evaporation system, either as liquid or as solid.

| | before | before | | | | |
|---|---|---|---|---|---|---|
| | Evapor- | Tubular | after Tubular | | after Strand | |
| Substance | ation | Evaporator | Evaporator | | Evaporator | |
| Polycarbonate | 16% | 70% | 99.95% | | 99.99% | |
| MCB | 39.5% | 25% | 400 | ppm | 115 | ppm |
| MeCl₂ | 44.5% | 5% | 0% | | | |
| BPA | | | 2 | ppm | 1 | ppm |
| Ph-Ph | | | 1% | | 0.92% | |
| oligomers | | | | | | |
| Cyclic | | | 1.22% | | 1.05% | |
| oligomers | | | | | | |
| Unknown | | | 0.06% | | 0.048% | |
| oligomers | | | | | | |
| Total oligomers | | | 2.33% | | 2.09% | |

| | before | before | | | | |
|---|---|---|---|---|---|---|
| | Evapor- | Tubular | after Tubular | | after Strand | |
| Substance | ation | Evaporator | Evaporator | | Evaporator | |
| Polycarbonate | 16% | 70% | 99.95% | | 99.99% | |
| MCB | 39.5% | 25% | 390 | ppm | 85 | ppm |
| MeCl₂ | 44.5% | 5% | 0% | | | |
| BPA | | | 2.2 | ppm | 1.5 | ppm |
| Ph-Ph | | | 1.02% | | 0.9% | |
| oligomers | | | | | | |
| Cyclic | | | 1.19% | | 1.02% | |
| oligomers | | | | | | |
| Unknown | | | 0.059% | | 0.039% | |
| oligomers | | | | | | |
| Total oligomers | | | 2.33% | | 2.05% | |

| | before | before | | | | |
|---|---|---|---|---|---|---|
| | Evapor- | Tubular | after Tubular | | after Strand | |
| Substance | ation | Evaporator | Evaporator | | Evaporator | |
| Polycarbonate | 16% | 70% | 99.95% | | 99.99% | |
| MCB | 39.5% | 25% | 420 | ppm | 95 | ppm |
| MeCl₂ | 44.5% | 5% | 0% | | | |
| BPA | | | 3 | ppm | 2 | ppm |
| Ph-Ph | | | 0.86% | | 0.78% | |
| oligomers | | | | | | |
| Cyclic | | | 1.1% | | 0.93% | |
| oligomers | | | | | | |
| Unknown | | | 0.066% | | 0.057% | |
| oligomers | | | | | | |
| Total oligomers | | | 2.09% | | 1.9% | |

The above examples show that the process according to the invention yields surprisingly low levels of Monomers and oligomers within the obtained Polycarbonate.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. In the process of producing polycarbonate resin by the phase interface method the improvement comprising adding at least one chlorinated aromatic hydrocarbon to the organic phase.

2. The process according to claim 1, wherein the chlorinated aromatic hydrocarbon is added in an amount of 0.001 to 90 wt. % relative to the organic phase.

3. The process according to claim 1 wherein the chlorinated aromatic hydrocarbon is added in an amount of 30 to 50 wt. % relative to the organic phase.

4. The polycarbonate prepared by the process according to claim 1.

5. A molded article comprising the polycarbonate of claim 4.

6. An extruded article comprising the polycarbonate of claim 4.
